(19) United States
(12) Patent Application Publication
(10) Pub. No.: US 2022/0112737 A1
(43) Pub. Date: Apr. 14, 2022

(54) CROSSARM FOR AN ELECTRICAL POLE

(71) Applicant: James E. Morrison, Albany, LA (US)

(72) Inventor: James E. Morrison, Albany, LA (US)

(21) Appl. No.: 17/067,664

(22) Filed: Oct. 10, 2020

(51) Int. Cl. E04H 12/24; H02G 7/20

(52) U.S. Cl. CPC E04H 12/24; E04H 12/08; H02G 7/20

(57) ABSTRACT

The present disclosure provides for an electrical utility temporary crossarm for quick connection to a crossarm of a utility pole. An end cap retention member is removably connected to a proximal end of an elongated crossarm of the electrical utility temporary crossarm and has an annular wall that includes one or more locking ribs arranged longitudinally and extending radially outwardly. A horn cap and a horn base is provided where each has a concave portion which defines a longitudinal support channel configured to receive the locking ribs in lock and key style arrangement. A wire holding member disposed on the distal end of the elongated crossarm member for receiving and securing an electrical wire.

### BACKGROUND OF THE INVENTION

### Field of the Invention

The present invention generally relates to temporary electric utility pole crossarms for temporarily supporting and repositioning energized power lines to enable repair or replacement of transmission or distribution crossarms, insulators, insulator pins and the like, and more particularly relates to a connection member assembly for connecting such temporary crossarms to crossarms of a utility pole.

### Description of the Related Art

High voltage transmission and distribution lines are typically strung between a series of spaced-apart support towers or poles. The conductors are connected to insulators mounted on or suspended from crossarms extending at the upper end of transmission or distribution poles, or conductor support points built into transmission towers. Periodically it is necessary to replace or repair the poles, towers, crossarms and insulators to maintain the electrical circuit in good working order. It is preferable if this maintenance and repair work can be performed without de-energizing the conductors in order to avoid an interruption of service to consumers, or to avoid the necessity of purchasing power from an alternative source, or other system disruptions.

Hot line repair work is a potentially hazardous undertaking. Safety regulations require that linemen maintain a minimum work clearance or “limit of approach” from energized conductors. The limit of approach varies depending upon the voltage of the conductors in question.

Conventional procedures used by linemen to temporarily support energized wires in order to enable repair of damaged or obsolete components involve the use of insulated wire tongs, lift poles and rope blocks in labor-intensive, complex rigging arrangements. Conventional fiberglass insulated tools are difficult to repair. Any accumulation of moisture which may impair their insulating property requires that the job be stopped, and that the conductors be placed in an insulator which is rated for all-weather use.

Several auxiliary crossarms have also been proposed in the past for temporarily supporting conductors, thereby reducing the need for labor-intensive “stick work” by linemen. For example, U.S. Pat. No. 4,973,795, which issued to Sharpe on Nov. 27, 1990, relates to an auxiliary crossarm consisting of an insulated boom fitted with polymer insulators and conductor hooks for releasably engaging energized conductors. The Sharpe boom is suspended from a crane above the transmission lines to be serviced.

Auxiliary crossarms for temporarily lifting and supporting energized conductors from below are also well known. Such crossarms typically have sleeves which are connectible to the boom jibs of derrick or bucket trucks.

A limitation of prior art boom-mounted auxiliary arms is that all of the conductors move together as a unit as the truck boom or overhead crane is adjusted. That is, operators are not able to independently control the motion of each separate conductor in order to maximize lineman working clearances or to relocate the conductors to a different spacing configuration.

While these units may be suitable for the particular purpose employed, they would not be as suitable for the purposes of the present invention as disclosed hereafter.

Conventional temporary crossarms for electrical poles have mechanical hardware permanently affixed to the temporary crossarms, such that when the material of the elongated member is worn out, the entire crossarm along with its fixed hardware must be taken out of field service and be replaced in its entirety, which is costly. Similarly, when a horn or a saddle support of a conventional crossarm is broken, then entire crossarm along with all mechanical fixtures attached to it must be taken out of service, such that the entire crossarm with its fixtures must be replaced in its entirety, which can be costly.

Accordingly, the need has arisen for a temporary electric utility pole crossarm for temporarily supporting energized wires which enables linemen to maximize field repair of temporary electric utility pole crossarms. A need exists for a more cost-effective repair of temporary crossarms for electrical poles.

Accordingly, there is a need for a temporary electric utility pole crossarm for attending to the installation and use of temporary electric utility pole crossarms in a more convenient, effective and efficient manner.

As disclosed in this application, the inventor has discovered novel and unique devices and methods for efficient connecting of temporary electric utility pole crossarms to crossarms of a utility pole, which provides field repair and replacement part capabilities without being dependent on fixed, expensive or complex components.

Embodiments of the present invention provide for devices and methods and disclosed herein and as defined in the annexed claims which provide for improved temporary electric utility pole crossarms and connector assemblies.

### SUMMARY OF THE INVENTION

It is one prospect of the present invention to provide one or more novel devices of simple but effective construction which can be applied to many environments to efficiently and effectively attach an electrical utility temporary crossarm to a crossarm of a utility pole.

The following presents a simplified summary of the present disclosure in a simplified form as a prelude to the more detailed description that is presented herein.

Therefore, in accordance with embodiments of the invention, there is provided an electrical utility temporary crossarm for quick connection to a crossarm of a utility pole.

The electrical utility temporary crossarm comprises an elongated crossarm member having a proximal end opposite a distal end. In a preferred embodiment, the elongated crossarm member is an elongated pole constructed of a composite fiberglass material having a round or cylindrical cross-section. Preferably, the electrical utility temporary crossarm includes an end cap retention member fixedly connected to the proximal end.

The end cap retention member includes an annular wall generally defining a longitudinal axis. The annular wall has a first end portion opposite a second end portion. The first end portion and the second end portion each respectively comprise a cylindrical flange extending outwardly therefrom. The annular wall defines an opening adapted to receive and secure the proximal end of the elongated crossarm member.

In a preferred embodiment, the annular wall includes a least a first locking rib arranged longitudinally and extending radially outwardly from the annular wall.

Preferably, the electrical utility temporary crossarm includes a horn cap removably connected to a horn base. The horn cap and horn base have opposing concave portions that are adapted to securely engage and surround the annular wall of the end cap retention member when positioned between the cylindrical flanges.

The horn cap and the horn base each define at least one longitudinal support channel configured to engage the at least first locking rib of the annular wall of the end cap retention member. The horn cap includes a pair of upwardly extending arms, and an upper end of each of the upwardly extending arms defines an internally threaded aperture that is adapted to receive and secure a respective fastening bolt threaded therethrough. The respective threaded fastening bolts are adapted to engage a side of the crossarm of the utility pole.

Preferably, the electrical utility temporary crossarm includes a wire holding member disposed on the distal end of the crossarm member, and the wire holding member is adapted to receive and secure an electrical wire.

In one embodiment, the annular wall of the end cap retention member of the electrical utility temporary crossarm also includes at least a second locking rib arranged longitudinally along the annular wall and extending radially outwardly from the annular wall of the end cap retention member. In a preferred embodiment, the at least one longitudinal support channel of the horn cap engages the at least first locking rib of the annular wall of the end cap retention member in a first lock and key style arrangement, and the at least one longitudinal support channel of the horn base engages the at least second locking rib of the annular wall of the end cap retention member in a second lock and key style arrangement.

Preferably, the at least first locking rib and the at least second locking rib of the electrical utility temporary crossarm extend radially outwardly from the annular wall by approximately equal heights. In another embodiment, the at least first locking rib and the at least second locking rib extend radially outwardly from the annular wall by unequal heights.

Preferably, the annular wall of the end cap retention member defines at least one aperture adapted to receive a fastener therethrough, and the fastener is adapted to connect the end cap retention member to the elongated crossarm member.

In yet another preferred embodiment, the horn cap of the electrical utility temporary crossarm also includes a plurality of teeth that are adopted to engage a portion of the crossarm of the utility pole when the electrical utility temporary crossarm is attached to the crossarm of the utility pole.

Preferably, the elongated crossarm member of the electrical utility temporary crossarm is constructed of a fiberglass composite, and the end cap retention member, horn cap and horn base are preferably constructed of aluminum.

In accordance with other embodiments of the invention, there is provided a connector assembly for quick connection of an electrical utility temporary crossarm to a crossarm of a utility pole. In a preferred embodiment, the connector assembly comprises an end cap retention member that is removably connected to an end of an elongated crossarm member of the electrical utility temporary crossarm. The end cap retention member includes an annular wall generally defining a longitudinal axis. The annular wall defines an open space configured to receive and securely engage the proximal end of the elongated crossarm member. The annular wall has a first end portion opposite a second end portion. The first end portion and the second end portion each respectively include a cylindrical flange which extends outwardly from the respective first end portion and second end end portion. The annular wall defines an opening adapted to receive and secure the proximal end of the elongated crossarm member. The annular wall preferably includes a least a first locking rib arranged longitudinally and extending radially outwardly from the annular wall.

In one embodiment, the connector assembly includes a horn cap removably connected to a horn base, and the horn cap and horn base each have opposing concave portions that are configured to come together to securely engage and surround the annular wall of the end cap retention member when the horn cap and horn base are positioned against the end cap retention member between the cylindrical flanges.

In a preferred embodiment, the opposing concave portions of the horn cap and horn base each define at least one longitudinal support channel configured to engage the at least first locking rib of the annular wall of the end cap retention member in a first lock and key style arrangement.

The at least one longitudinal support channel of the horn cap is preferably disposed at the at a top, central location of the concave portion of the horn cap. The at least one longitudinal support channel of the horn base is preferably disposed at a bottom, central location of the concave portion of the horn base. Preferably, the at least one longitudinal support channel of the horn base opposes the at least one longitudinal support channel of the horn base, because such manner better enables the horn cap and horn base to encircle and connect to the annular wall of the end cap retention member.

The horn cap of the connector assembly comprises a pair of upwardly extending arms. A top of each of the upwardly extending arms preferably defines an internally threaded aperture that is adapted to receive and secure a respective fastening bolt threaded through the internally threaded aperture. Each of the respective threaded fastening bolts is adapted to engage a side of the crossarm of the utility pole.

In one embodiment, the annular wall of the end cap retention member of the connector assembly preferably comprises at least a second locking rib arranged longitudinally along the annular wall, and the second locking rib arranged extends radially outwardly from the annular wall. The at least one longitudinal support channel of the horn cap engages the at least first locking rib of the annular wall of the end cap retention member in the first lock and key style arrangement, and the at least one longitudinal support channel of the horn base engages the at least second locking rib of the annular wall of the end cap retention member in a second lock and key style arrangement.

In one embodiment, the annular wall of the end cap retention member of the connector assembly defines at least one aperture adapted to receive a fastener therethrough, and the fastener is adapted to connect the end cap retention member to the elongated crossarm member when the end cap retention member has received the proximal end of the elongated crossarm member.

In another embodiment, the annular wall of the end cap retention member of the connector assembly defines at least two apertures, and each aperture is adapted to receive a respective fastener through the aperture to connect the end cap retention member to the elongated crossarm member with two fasteners.

In a preferred embodiment, the annular wall of the end cap retention member of the connector assembly defines at least three apertures, which are arranged and spaced annularly around the end cap retention member, and each aperture is adapted to receive a respective fastener through such aperture to connect the end cap retention member to the elongated crossarm member with three fasteners.

The horn cap of the connector assembly preferably includes a plurality of teeth adopted to engage a portion of the crossarm of the utility pole when the connector assembly is attached to the crossarm of the utility pole.

In one embodiment, the horn cap of the connector assembly preferably includes a flanged bottom portion defining a first plurality of apertures, and the horn base has a flanged top portion defining a second plurality of apertures. The first plurality of apertures aligns with said second plurality of apertures when the horn cap is connected to the horn base. Fasteners can be inserted through such apertures, when aligned, in order to fasten together the horn cap and the horn base.

The opposing concave portions of the horn cap and the horn base each preferably define at least one inner annular groove, each of which is adapted to receive and enclose a head of a fastener when the opposing concave portions surround and engage the end cap retention member. The at least one inner annular groove of the concave portion of the horn cap and the at least one inner annular groove of the concave portion of the horn base are preferably disposed along an axis tangential to an axis of the longitudinal support channel, and preferably tangential to the longitudinal axis.

In one embodiment, the end cap retention member of the connector assembly further includes a planar wall disposed at the first end portion, and the planar wall is positioned transverse to the longitudinal axis.

In a preferred embodiment, the horn cap, horn base, and end cap retention member connector assembly are constructed of aluminum.

In accordance with other embodiments of the invention, there is provided a hanger saddle assembly for an electrical utility temporary crossarm for quick connection to a crossarm of a utility pole. The hanger saddle assembly comprises a stirrup member having a pair of downwardly extending legs. Each downwardly extending leg has a respective bottom end portion which defines at least one aperture adapted to receive an elongated fastener through the respective at least one aperture.

In one embodiment, the hanger saddle assembly includes a first clamp member having a concave region to accommodate a first portion of the temporary crossarm. Preferably, the first clamp member has a first angled region having a first lateral edge extending from an upper end of the concave region. The first clamp member also has an upper end defining a first aperture that is adapted to receive the elongated fastener through the first aperture. The hanger saddle assembly includes a second clamp member having a concave region to accommodate a second portion of the temporary crossarm. The second clamp member includes a second angled region having a second lateral edge extending from an upper end of its concave region. The second clamp member has an upper end which defines a second aperture that is configured to receive the elongated fastener therethrough.

The hanger saddle assembly includes a hinge that rotatably attaches the first clamp member to the second clamp member about a hinge axis. The hinge axis is characterized as parallel to the longitudinal axis of the temporary crossarm.

In another embodiment, each downwardly extending leg has a respective bottom end portion defining at least a second aperture, and the second aperture is adapted to receive an elongated fastener therethrough, for adjusting a height of the temporary crossarm relative to the crossarm of the utility pole when said hanger saddle assembly is mounted on the crossarm of the utility pole.

In yet another embodiment, the hanger saddle assembly further includes an elongated fastener extending through the at least one aperture of each downwardly extending leg and extending through the first aperture of the first clamp member and through the second aperture of the second clamp member. In such embodiment, the elongated fastener is adapted to secure the bottom end portion of each downwardly extending leg to the first clamp member and to the second clamp member while clamping the first clamp member and second clamp member around the first and second portions of the temporary cross-arm.

In one embodiment, the stirrup member of the hanger saddle assembly is characterized as U-shaped. In another embodiment, the stirrup member of the hanger saddle assembly is characterized as C-shaped.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a top front left perspective view of an exemplary electrical utility temporary crossarm device connected to a crossarm of a utility pole in accordance with embodiments of the invention;

FIG. 2 is a detailed top front left perspective view thereof;

FIG. 3 is a top front right perspective view of an exemplary electrical utility temporary crossarm device in accordance with embodiments of the invention;

FIG. 4 is a top front right perspective view without a wire holder thereof;

FIG. 5 is a top front left perspective view of an exemplary horn cap in accordance with embodiments of the invention;

FIG. 6 is a front elevation view thereof;

FIG. 7 is a side elevation view thereof;

FIG. 8 is a top front left perspective view of an exemplary horn base in accordance with embodiments of the invention;

FIG. 9 is a side elevation view thereof;

FIG. 10 is a font elevation view thereof;

FIG. 11 is a top front right perspective view of an exemplary end cap retention member in accordance with embodiments of the invention;

FIG. 12 is a front elevation view thereof;

FIG. 13 is a top elevation view thereof;

FIG. 13A is a cross-section view of an exemplary end cap retention member and of concave portions of a horn cap and a horn base taken along line AA;

FIG. 13B is a front elevation view of a horn cap, a horn base and an end cap retention member, in accordance with embodiments of the invention;

FIG. 13C is an exploded view of a horn cap, horn base and end cap retention member, in accordance with embodiments of the invention;

FIG. 14 is a top front left perspective view of a first clamp member of an exemplary hanger saddle assembly in accordance with embodiments of the invention;

FIG. 15 is a side elevation view thereof;

FIG. 16 is a top front left perspective view of a second clamp member of an exemplary hanger saddle assembly in accordance with embodiments of the invention;

FIG. 17 is a side elevation view thereof;

FIG. 18 is front right perspective view of a first clamp member connected to a second clamp member of an exemplary hanger saddle assembly, in accordance with embodiments of the invention; and

FIG. 19 is front elevation view of a first clamp member connected to a second clamp member of the exemplary hanger saddle assembly, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

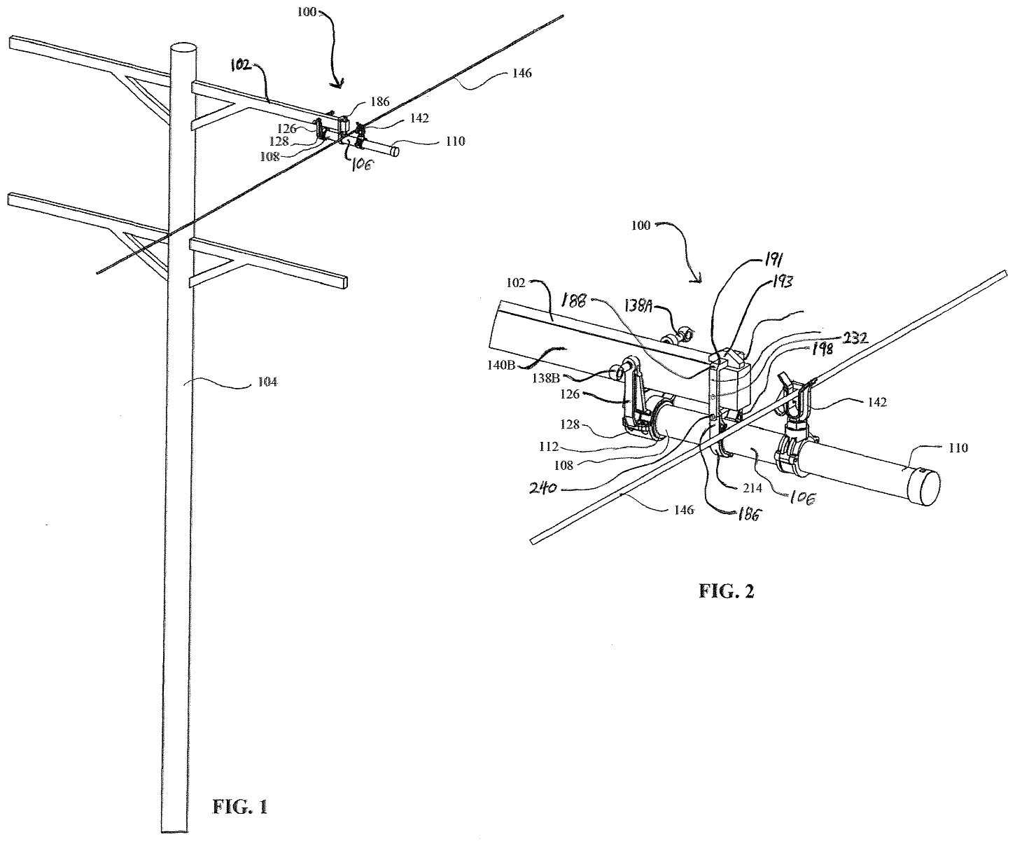

Referring initially to FIGS. 1-17, the basic constructional details and principles of operation of one embodiment of an electrical utility temporary crossarm 100 for quick connection to a crossarm 102 of a utility pole 104 according to a preferred embodiment of the present invention will be discussed.

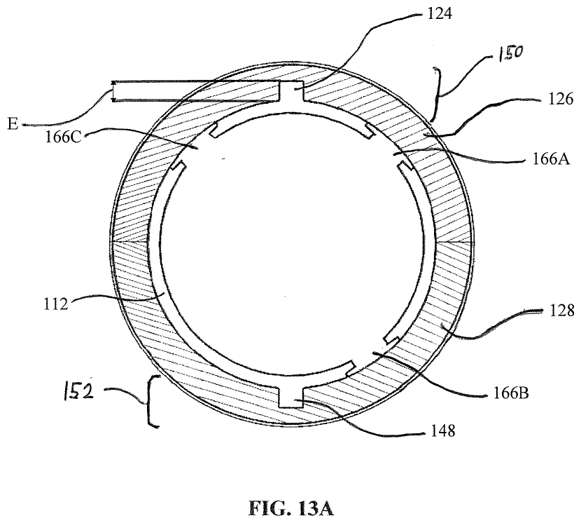

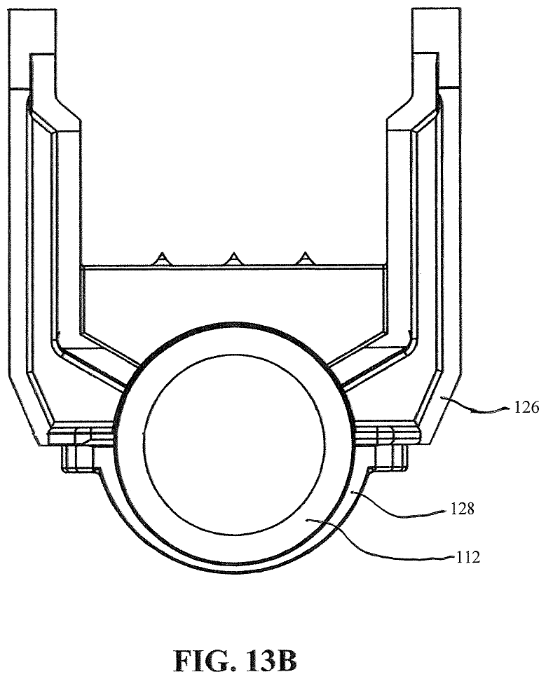

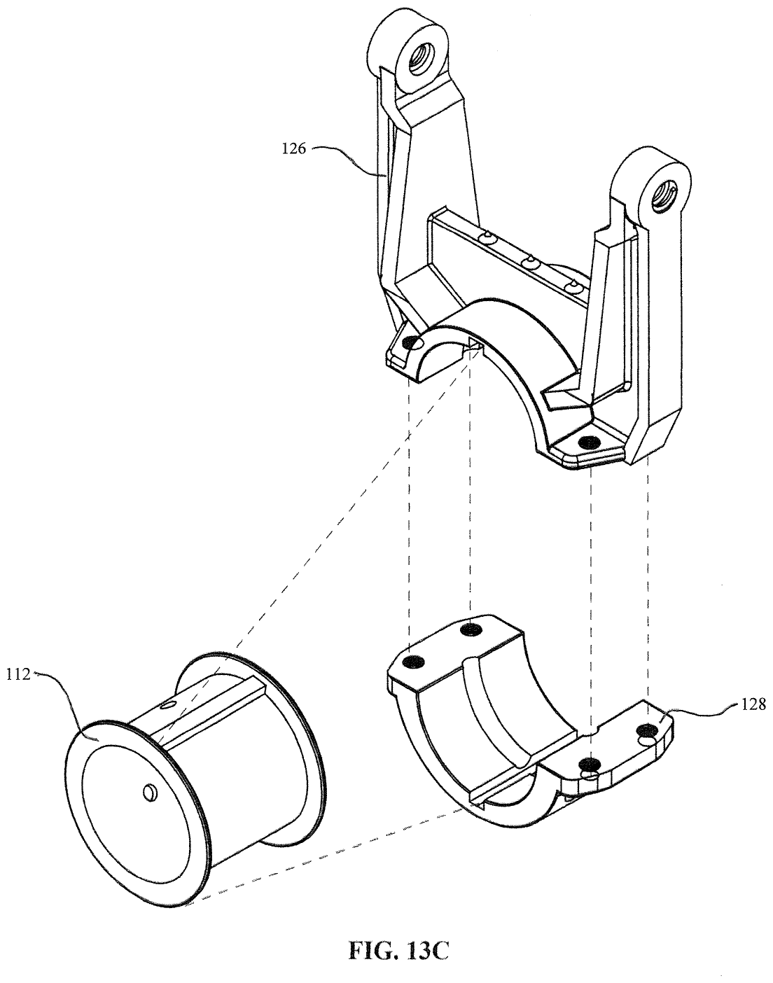

As illustrated in FIGS. 1-3, the electrical utility temporary crossarm 100 for quick connection to a crossarm 102 of a utility pole 104 includes an elongated crossarm member 106. The elongated crossarm member 106 has a proximal end 108 opposite a distal end 110. In one embodiment, the elongated crossarm member 106 is an elongated pole constructed of a composite fiberglass material having a round or cylindrical cross-section, as illustrated in FIGS. 1-3. Preferably, the elongated crossarm member 106 has an end cap retention member 112, which is fixedly connected to the proximal end 108. The end cap retention member 112 includes an annular wall 114, which generally defines a longitudinal axis A. The annular wall 114 has a first end portion 116 opposite a second end portion 118. The first end portion 116 and the second end portion 118 each respectively include a cylindrical flange 120, 121. The annular wall 114 defines an opening 122 adapted to receive and secure the proximal end 108 of the elongated crossarm member 106. The annular wall 114 includes at least a first locking rib 124 arranged longitudinally and extending radially outwardly from the annular wall 114. In a preferred embodiment, the elongated crossarm member 106 includes a horn cap 126 removably connected to a horn base 128. The horn cap 126 and horn base 128 have opposing concave portions 130, 131. The disclosed invention provides a more cost-effective repair of temporary crossarms for electrical poles. Moreover, embodiments of the disclosed invention enables linemen to undertake and maximize field repair of temporary crossarms for electric utility poles. Each of the opposing concave portions 130, 131 are adapted to securely engage and surround the annular wall 114 of the end cap retention member 112 when positioned between the cylindrical flanges 120, 121, as illustrated in the cross-section view in FIG. 13A. From this disclosure herein, it can be appreciated by those of ordinary skill in the art that when the material of the elongated member 106 is worn out during service, then a lineman can remove the horn cap 126 and the horn base 128 from the elongated member 106 of the electrical temporary crossarm 100, and the lineman can connect the horn cap 126 and the horn base 128 to a new elongated crossarm member, while in the field. The horn cap 126 and the horn base 128 can be re-used, obviating the need to take them out of service and avoiding the otherwise wasted cost of disposal of a conventional horn.

As illustrated in FIG. 13B, the horn cap 126 and horn base 128 securely engage and surround the annular wall 114 of the end cap retention member 112, as the respective concave portions 130, 131 of the horn cap 126 and horn base 128 are positioned between the cylindrical flanges 120, 121 of the end cap retention member 112, in accordance with embodiments of the invention. FIG. 13C provides an exploded view of a horn cap 126, a horn base 128 and an end cap retention member 112, in accordance with embodiments of the invention.

Preferably, the horn cap 126 and the horn base 128 each define at least one longitudinal support channel 132, 133 configured to engage the at least first locking rib 124 of the annular wall 114 of the end cap retention member 112. The horn cap 126 includes a pair of upwardly extending arms 134A, 134B. Each of the upwardly extending arms 134A, 134B define an internally threaded aperture 136A, 136B. The respective internally threaded aperture 136A, 136B is adapted to receive and secure a respective fastening bolt 138A, 138B threaded therethrough. Each of the respective threaded fastening bolt 138A, 138B is adapted to engage a side 140A, 140B of the crossarm 102 of the utility pole 104. The elongated crossarm member 106 includes a wire holding member 142 oriented on the distal end 110 of the elongated crossarm member 106. The wire holding member 142 is adapted to receive and secure an electrical wire 146.

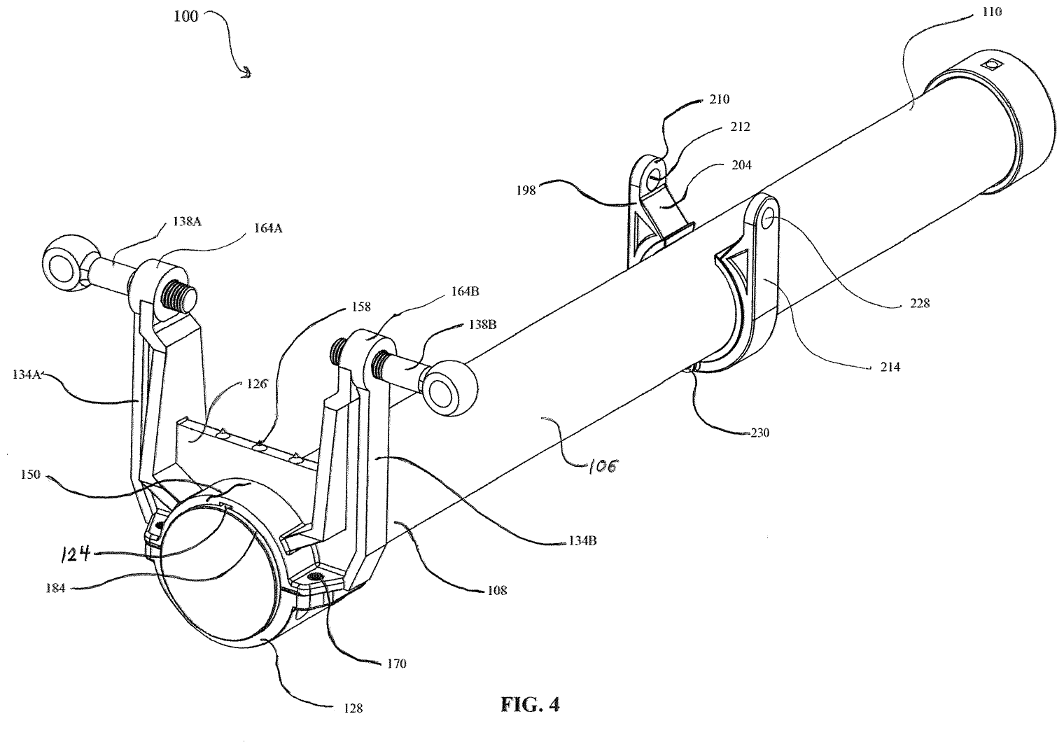

In one embodiment, as illustrated in FIGS. 11 and 13, the annular wall 114 of the end cap retention member 112 also includes at least a second locking rib 148 arranged longitudinally along the annular wall 114 and extending radially outwardly from the annular wall 114. The at least one longitudinal support channel 132 of the horn cap 126 engages the at least first locking rib 124 of the annular wall 114 of the end cap retention member 112 in a first lock and key style arrangement 150, as illustrated in the cross-section view in FIG. 13A. The at least one longitudinal support channel 133 of the horn base 128 engages the at least second locking rib 148 of the annular wall 114 of the end cap retention member 112 in a second lock and key style arrangement 152, as shown in FIGS. 3-4.

In another embodiment, as shown in FIG. 13, the at least first locking rib 124 and the at least second locking rib 148 extend radially outwardly from the annular wall 114 by approximately equal heights. As illustrated in FIG. 13A, a height E of the at least first locking rib 124 is approximately equal to that of the at least second locking rib 148.

In yet another embodiment, the at least first locking rib 124 and the at least second locking rib 148 extend radially outwardly from the annular wall 114 by unequal heights. In this context, height is meant as the extent that the locking rib extends radially outwardly form the annular wall 114. One skilled in the art would understand that a height E of the at least first locking rib 124 can be higher or lower (i.e., greater or lesser) than a height of the at least second locking rib 148.

In one embodiment, as illustrated in FIGS. 11 and 13, the annular wall 114 of the end cap retention member 112 defines at least one aperture 154 adapted to receive a fastener 156 therethrough. The fastener 156 is adapted to connect the end cap retention member 112 to the elongated crossarm member 106.

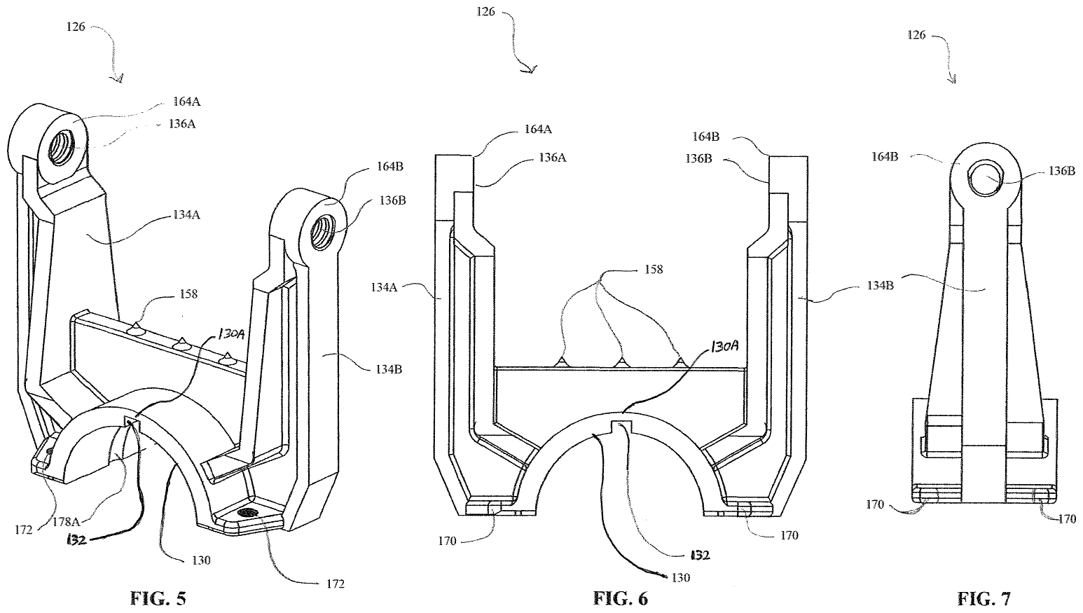

In another embodiment, as shown in FIGS. 5-6, the horn cap 126 also includes a plurality of teeth 158 adopted to engage a portion 160 of the crossarm 102 of the utility pole 104 when attached thereon.

In yet another embodiment, the elongated crossarm member 106 is constructed of a fiberglass composite and the end cap retention member 112, the horn cap 126, and the horn base 128 are constructed of aluminum.

Referring to FIGS. 1-13, the basic constructional details and principles of operation of preferred embodiments of a connector assembly 162 for quick connection of an electrical utility temporary crossarm 100 to a crossarm 102 of a utility pole 104 according to a preferred embodiment of the present invention will be discussed.

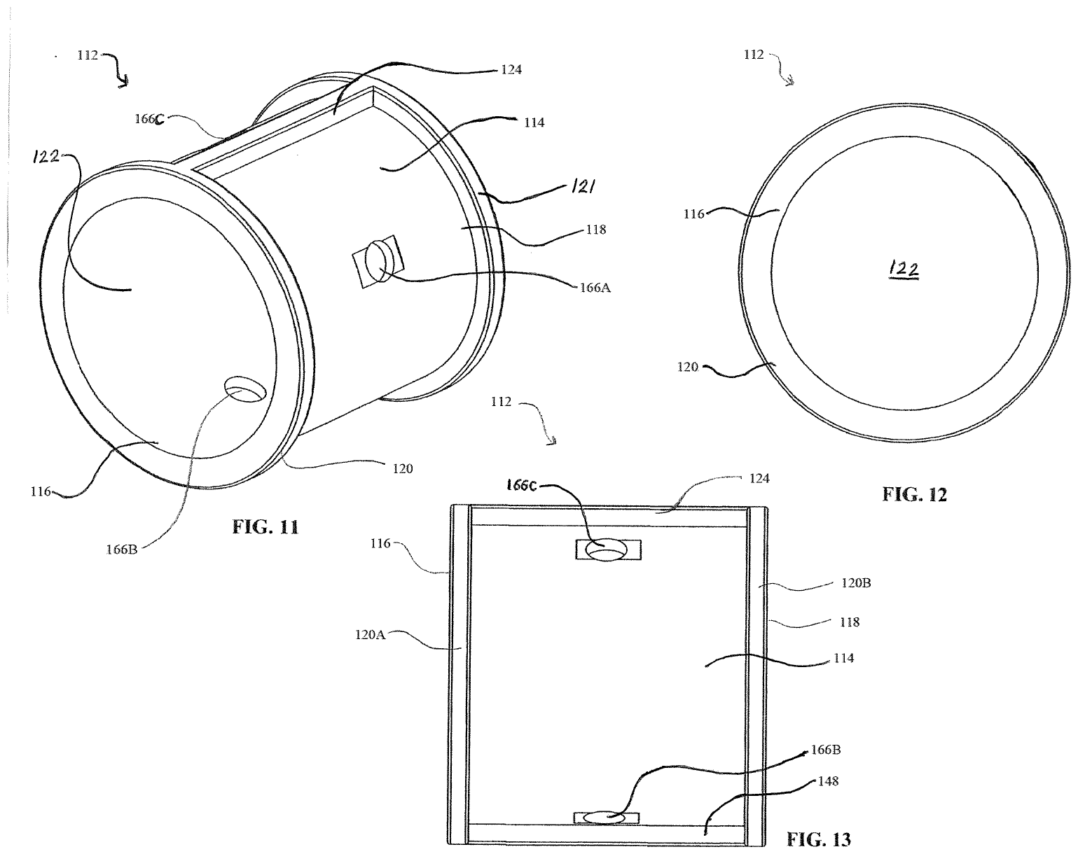

As shown in FIGS. 3-13, the connector assembly 162 includes an end cap retention member 112 removably connected to an end 108 of an elongated crossarm member 106 of the electrical utility temporary crossarm 100. The end cap retention member 112 includes an annular wall 114, which generally defines a longitudinal axis A. The annular wall 114 defines an opening 122, as illustrated in FIGS. 11-12, which is adapted to receive and secure a proximal end 108 of the elongated crossarm member 106. The annular wall 114 has a first end portion 116 opposite a second end portion 118. The first end portion 116 and the second end portion 118 each respectively include a cylindrical flange 120, 121, as shown in FIG. 13. Preferably, the opening 122 defined by the annular wall 114 is adapted to receive and secure a proximal end 108 of the elongated crossarm member 106. The annular wall 114 also includes at least a first locking rib 124 arranged longitudinally and extending radially outwardly from the annular wall 114. The connector assembly 162 includes a horn cap 126 removably connected to a horn base 128. The horn cap 126 and the horn base 128 each have opposing concave portions 130, 131, which are adapted to securely engage and surround the annular wall 114 of the end cap retention member 112 when positioned between the cylindrical flanges 120, 121, as shown in FIGS. 3-4. The opposing concave portions 130, 131 of the horn cap 126 and the horn base 128 each define at least one longitudinal support channel 132, 133, which are respectively configured to engage the at least first locking rib 124 of the annular wall 114 of the end cap retention member 112 in a first lock and key style arrangement 150. The horn cap 126 includes a pair of upwardly extending arms 134A, 134B. A top 164A, 164B of each of the upwardly extending arms 134A, 134B preferably defines an internally threaded aperture 136A, 136B that is adapted to receive and secure a respective fastening bolt 138A, 138B threaded through the respective internally threaded aperture 136A, 136B. Each of the respective threaded fastening bolts 138A, 138B is adapted to engage a side 140A, 140B of the crossarm 102 of the utility pole 104.

In one embodiment, as illustrated in FIG. 13, the annular wall 114 of the end cap retention member 112 also includes at least a second locking rib 148 arranged longitudinally along the annular wall 114 and extending radially outwardly from the annular wall 114. The at least one longitudinal support channel 132 of the horn cap 126 engages the at least first locking rib 124 of the annular wall 114 of the end cap retention member 112 in the first lock and key style arrangement 150. The at least one longitudinal support channel 133 of the horn base 128 engages the at least second locking rib 148 of the annular wall 114 of the end cap retention member 112 in a second lock and key style arrangement 152.

In another embodiment, the at least one longitudinal support channel 132 of the horn cap 126 is preferably disposed at a top, central location 130A of the concave portion 130 of the horn cap 126. The at least one longitudinal support channel 133 of the horn base 128 is preferably disposed at a bottom, central location 131A of the concave portion 131 of the horn base 128. Preferably, the at least one longitudinal support channel 132 of the horn cap 126 opposes the at least one longitudinal support channel 133 of the horn base 128, because such preferred embodiment better enables the horn cap 126 and horn base 128 to firmly encircle, engage, and removably connect to the annular wall 114 of the end cap retention member 112.

As illustrated in FIGS. 3, 4, 11 and 13, in one embodiment, the annular wall 114 of the end cap retention member 112 of the connector assembly 162 defines at least one aperture 154 adapted to receive a fastener 156 therethrough, and the fastener 156 is adapted to connect the end cap retention member 112 to the elongated crossarm member 106 when the end cap retention member 112 has received the proximal end 108 of the elongated crossarm member 106.

In another embodiment, the annular wall 114 of the end cap retention member 112 of the connector assembly 162 defines at least two apertures 166A, 166B, and each of the at least two apertures 166A, 166B is adapted to receive a respective fastener 168A, 168B through the respective aperture 166A, 166B to fasten the end cap retention member 112 to the elongated crossarm member 106 with respective fastener 168A, 168B, as shown in FIGS. 3, 4, 11 and 13.

As illustrated in FIGS. 11 and 13, in a preferred embodiment, the annular wall 114 of the end cap retention member 112 of the connector assembly 162 defines at least three apertures 166A, 166B, 166C, which are arranged and spaced annularly around the end cap retention member 112, and each aperture 166A, 166B, 166C is adapted to receive a respective fastener 168A, 168B, 168C through such aperture 166A, 166B, 166C to fasten the end cap retention member 112 to the elongated crossarm member 106 with three fasteners 168A, 168B, 168C.

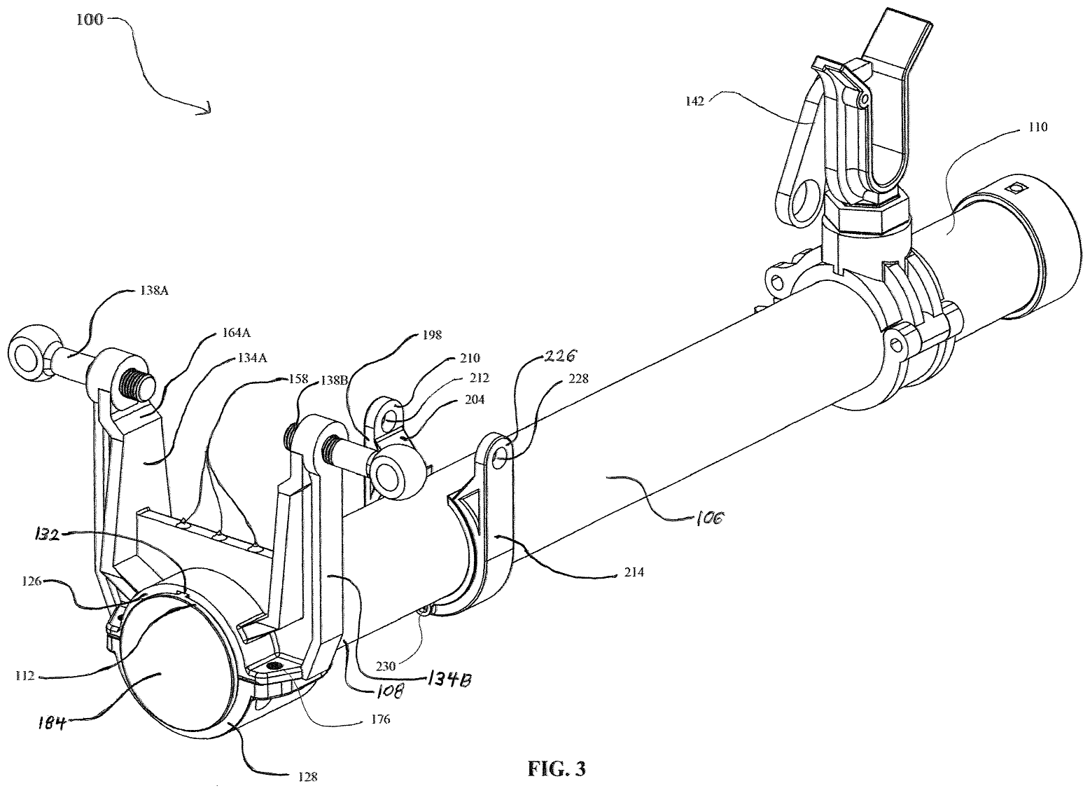

In one embodiment, the horn cap 126 of the connector assembly 162 preferably includes a plurality of teeth 158 adopted to engage a portion 160 of the crossarm 102 of the utility pole 104 when the connector assembly 162 is attached to the crossarm 102 of the utility pole 104, as illustrated in FIGS. 1-2.

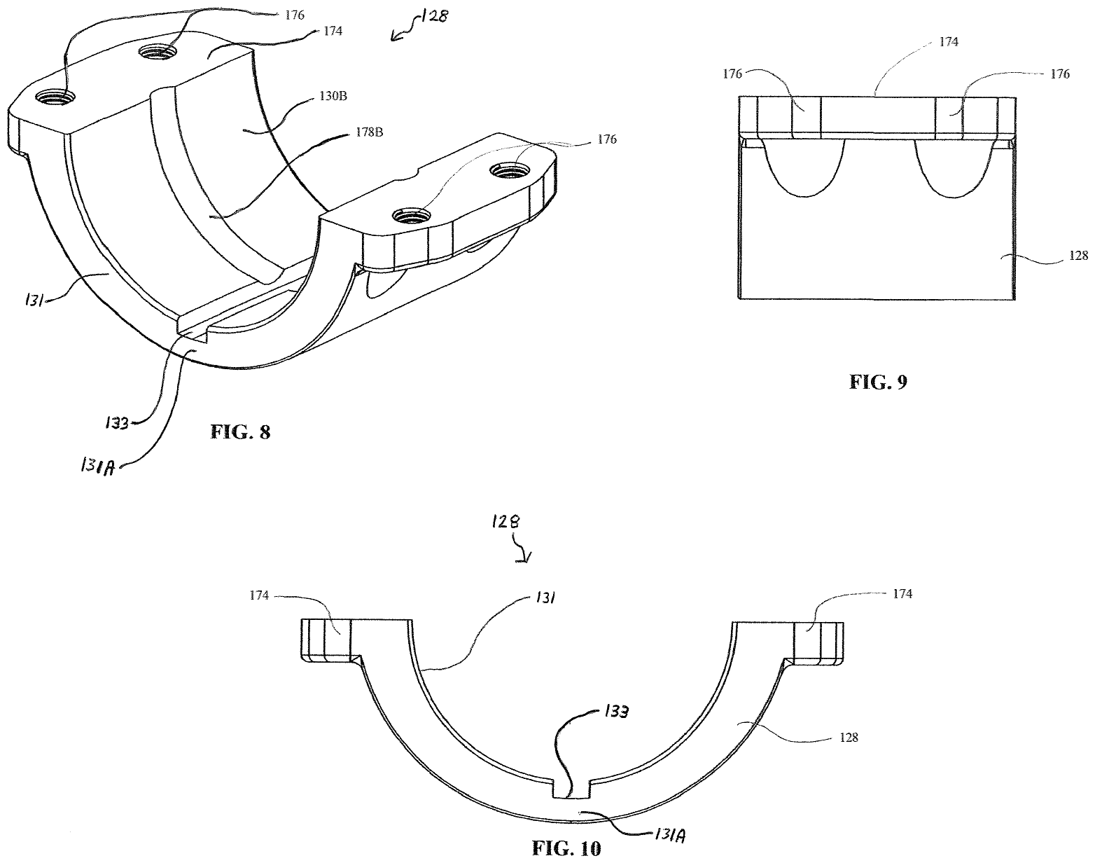

In one embodiment, as shown in FIGS. 3-6, and 8-10, the horn cap 126 of the connector assembly 162 preferably includes a flanged bottom portion 170 defining a first plurality of apertures 172, and the horn base 128 has a flanged top portion 174 defining a second plurality of apertures 176. The first plurality of apertures 172 and the second plurality of apertures 176 are preferably internally threaded, as illustrated in FIG. 8. The first plurality of apertures 172 aligns with said second plurality of apertures 176 when the horn cap 126 is connected to the horn base 128. Fasteners can be inserted through such apertures 172, 176, when aligned, in order to fasten together the horn cap 126 and the horn base 128.

As seen in FIGS. 5 and 8, the opposing concave portions 130, 131 of the horn cap 126 and the horn base 128 each preferably define at least one inner annular groove 178A, 178B, each of which is adapted to receive and enclose a head of a fastener 180 when the opposing concave portions 130, 131 surround and engage the end cap retention member 112. The at least one inner annular groove 178A of the concave portion 130 of the horn cap 126 and the at least one inner annular groove 178B of the concave portion 131 of the horn base 128 are preferably disposed along an axis B tangential to an axis of the longitudinal support channel C, and preferably tangential to the longitudinal axis A.

In one embodiment, the end cap retention member 112 of the connector assembly 162 further includes a planar wall 184 disposed at the first end portion 116, and the planar wall 184 is positioned transverse to the longitudinal axis A.

In a preferred embodiment, the horn cap 126, the horn base 128, the end cap retention member 112, connector assembly 162 are constructed of aluminum.

In accordance with other embodiments of the disclosed invention, there is provided a hanger saddle assembly 186 for an electrical utility temporary crossarm 100 for quick connection to a crossarm 102 of a utility pole 104. As illustrated in FIGS. 1-2, the hanger saddle assembly 186 comprises a stirrup member 188 having a top horizontal member 191 and a pair of downwardly extending legs 190A, 190B, which extend down from the top horizontal member 191. Preferably, a triangular foot 193 is disposed in the middle of the top horizontal member 191, and the triangular foot 193 is positioned transverse or perpendicular to the top horizontal member 191.

Each downwardly extending leg 190A, 190B of the stirrup member 188 has a respective bottom end portion 192A, 192B which defines at least one aperture 194A, 194B adapted to receive an elongated fastener 196A, 196B through the respective at least one aperture 194A, 194B.

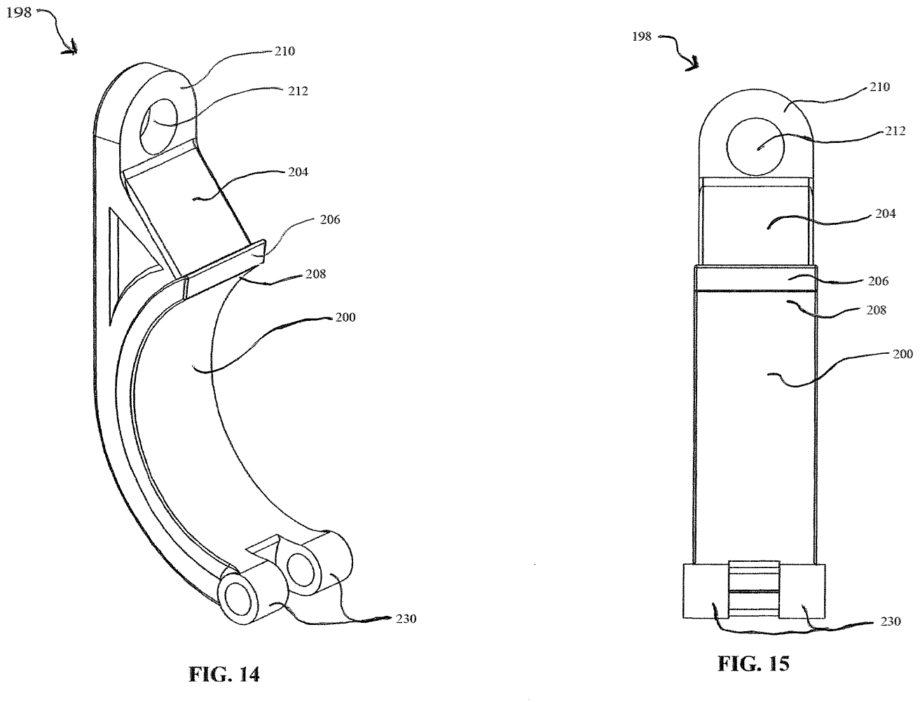

As illustrated in FIGS. 14-15, the hanger saddle assembly 186 includes a first clamp member 198 having a concave region 200 to accommodate a first portion 202 of the electrical utility temporary crossarm 100. Preferably, the first clamp member 198 has a first angled region 204 having a first lateral edge 206 extending from an upper end 208 of the concave region 200. The first clamp member 198 also has an upper end 210 defining a first aperture 212 that is adapted to receive the elongated fastener 196A through the first aperture 212.

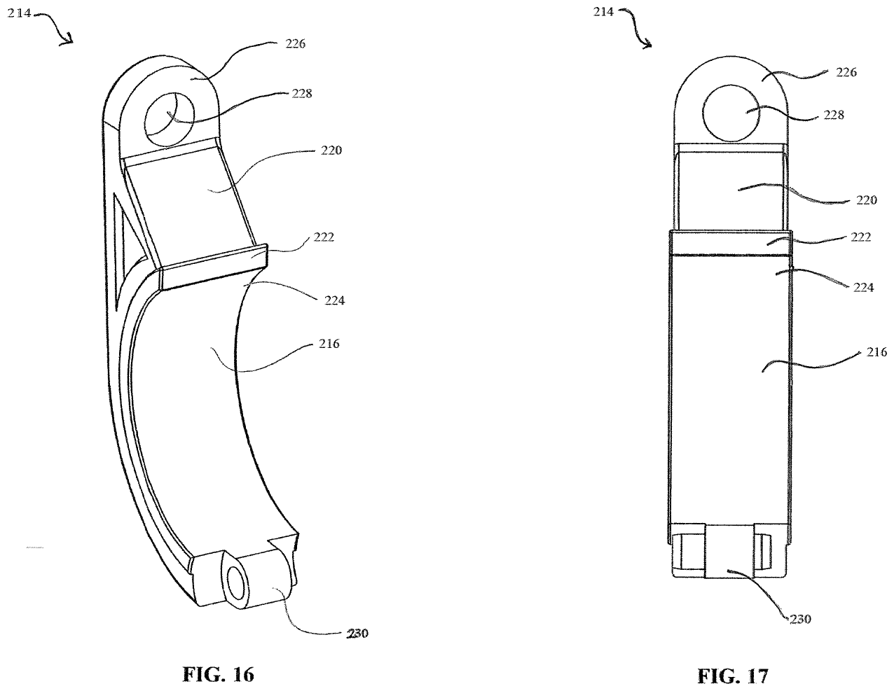

As illustrated in FIGS. 16-17, the hanger saddle assembly 186 also includes a second clamp member 214 having a concave region 216 to accommodate a second portion 218 of the electrical utility temporary crossarm 100. The second clamp member 214 includes a second angled region 220 having a second lateral edge 222 extending from an upper end 224 of the concave region 216 of the second clamp member 214. The second clamp member 214 has an upper end 226, which defines a second aperture 228 that is configured to receive the elongated fastener 196B therethrough.

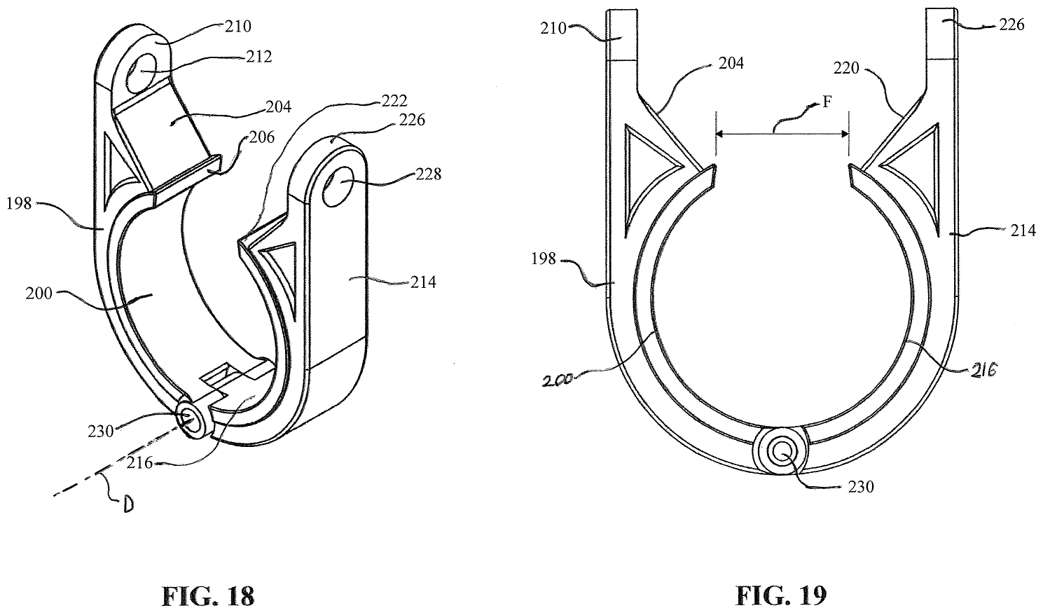

In such preferred embodiment, the hanger saddle assembly 186 includes a hinge 230 that rotatably attaches the first clamp member 198 to the second clamp member 214 about a hinge axis D, as illustrated in FIGS. 18-19, in accordance with embodiments of the invention. The hinge axis D is characterized as parallel to the longitudinal axis A of the temporary crossarm 100. The first lateral edge 206 extending from the upper end 208 of the concave region 200 of the first clamp member 198 is separated from the second lateral edge 222 extending from the upper end 224 of the concave region 216 of the second clamp member 214 by a gap F, as shown in FIG. 19. Conventionally, elongated pole members of temporary crossarms would need to be cut or broken in order to remove and replace a support for a stirrup member that is attached to the elongated pole member, which is impractical given the cost of the elongated pole members of the temporary crossarm members. Such embodiments of the disclosed invention obviate the need to break or cut a temporary crossarm 102 because the hanger saddle assembly 186 can be removed from the crossarm member 102 by releasing the first clamp member 198 and the second clamp member 214.

In one embodiment, as shown in FIGS. 1-2, each of the pair of downwardly extending legs 190A, 190B has a respective bottom end portion 192A, 192B defining at least a second aperture 232, and the second second aperture 232 is adapted to receive an elongated fastener 234 therethrough, for adjusting a height 236 of the electrical utility temporary crossarm 100 relative to the crossarm 102 of the utility pole 104 when said hanger saddle assembly 186 is mounted on the crossarm 102 of the utility pole 104.

In another embodiment, the hanger saddle assembly 186 further includes an elongated fastener 240 extending through the at least one aperture 194A, 194B of each downwardly extending leg 190A, 190B and extending through the first aperture 212 of the first clamp member 198 and through the second aperture 228 of the second clamp member 214. In such embodiment, the elongated fastener 240 is adapted to secure the bottom end portion 192A, 192B of each downwardly extending leg 190A, 190B to the first clamp member 198 and to the second clamp member 214 while clamping the first clamp member 198 and second clamp member 214 around the first portion 202 and the second portion 218 of the temporary crossarm 100, as illustrated in FIGS. 1-2.

In yet another embodiment, as shown in FIGS. 1-2, the stirrup member 188 of the hanger saddle assembly 186 is characterized as U-shaped. In yet another embodiment, the stirrup member 188 of the hanger saddle assembly 186 is characterized as C-shaped.

All U.S. patents and publications identified herein are incorporated in their entirety by reference thereto.

The claimed invention is:

1. An electrical utility temporary crossarm for quick connection to a crossarm of a utility pole, comprising:
an elongated crossarm member having a proximal end opposite a distal end;
an end cap retention member fixedly connected to the proximal end, said end cap retention member comprising an annular wall generally defining a longitudinal axis, said annular wall having a first end portion opposite a second end portion, the first end portion and the second end portion each respectively comprising a cylindrical flange said annular wall defining an opening adapted to receive and secure the proximal end of the elongated crossarm member, said annular wall comprising at least a first locking rib arranged longitudinally and extending radially outwardly from the annular wall;
a horn cap removably connected to a horn base, said horn cap and horn base having opposing concave portions adapted to securely engage and surround the annular wall of the end cap retention member when positioned between the cylindrical flanges;
wherein said horn cap and said horn base each define at least one longitudinal support channel configured to engage the at least first locking rib of the annular wall of the end cap retention member;
said horn cap comprising a pair of upwardly extending arms, each of said arms defining an internally threaded aperture adapted to receive and secure a respective fastening bolt threaded therethrough, wherein each said respective threaded fastening bolt adapted to engage a side of the crossarm of the utility pole; and
a wire holding member disposed on the distal end of the elongated crossarm member, said wire holding member adapted to receive and secure an electrical wire.

2. The electrical utility temporary crossarm of claim 1, said annular wall of the end cap retention member further comprising at least a second locking rib arranged longitudinally along the annular wall and extending radially outwardly from the annular wall, wherein the at least one longitudinal support channel of the horn cap engages the at least first locking rib of the annular wall of the end cap retention member in a first lock and key style arrangement, wherein the at least one longitudinal support channel of the horn base engages the at least second locking rib of the annular wall of the end cap retention member in a second lock and key style arrangement.

3. The electrical utility temporary crossarm of claim 2, wherein the at least first locking rib and the at least second locking rib extend radially outwardly from the annular wall by approximately equal heights.

4. The electrical utility temporary crossarm of claim 2, wherein the at least first locking rib and the at least second locking rib extend radially outwardly from the annular wall by unequal heights.

5. The electrical utility temporary crossarm of claim 1, wherein the annular wall of the end cap retention member defines at least one aperture adapted to receive a fastener therethrough, said fastener adapted to connect said end cap retention member to the elongated crossarm member.

6. The electrical utility temporary crossarm of claim 1, said horn cap further comprising a plurality of teeth adopted to engage a portion of the crossarm of the utility pole when attached thereon.

7. The electrical utility temporary crossarm of claim 1, wherein the elongated crossarm member is constructed of a fiberglass composite, wherein the end cap retention member, horn cap and horn base are constructed of aluminum.

8. A connector assembly for quick connection of an electrical utility temporary crossarm to a crossarm of a utility pole, comprising:
an end cap retention member removably connected to an end of an elongated crossarm member of the electrical utility temporary crossarm, said end cap retention member comprising an annular wall generally defining a longitudinal axis, said annular wall having a first end portion opposite a second end portion, the first end portion and the second end portion each respectively comprising a cylindrical flange, said annular wall defining an opening adapted to receive and secure the proximal end of the elongated crossarm member, said annular wall comprising at least a first locking rib arranged longitudinally and extending radially outwardly from the annular wall;
a horn cap removably connected to a horn base, said horn cap and said horn base each having opposing concave portions adapted to securely engage and surround the annular wall of the end cap retention member when positioned between the cylindrical flanges;
wherein the opposing concave portions of said horn cap and said horn base each define at least one longitudinal support channel configured to engage the at least first locking rib of the annular wall of the end cap retention member in a first lock and key style arrangement;
said horn cap comprising a pair of upwardly extending arms, each of said arms defining an internally threaded aperture adapted to receive and secure a respective fastening bolt threaded therethrough, wherein each said respective threaded fastening bolt adapted to engage a side of the crossarm of the utility pole.

9. The connector assembly of claim 8, said annular wall of the end cap retention member further comprising at least a second locking rib arranged longitudinally along the annular wall and extending radially outwardly from the annular wall, wherein the at least one longitudinal support channel of the horn cap engages the at least first locking rib of the annular wall of the end cap retention member in the first lock and key style arrangement, wherein the at least one longitudinal support channel of the horn base engages the at least second locking rib of the annular wall of the end cap retention member in a second lock and key style arrangement.

10. The connector assembly of claim 8, wherein the annular wall of the end cap retention member defines at least one aperture adapted to receive a fastener therethrough wherein said fastener is adapted to connect said end cap retention member to the elongated crossarm member.

11. The connector assembly of claim 8, wherein the annular wall of the end cap retention member defines at least two apertures wherein each aperture is adapted to receive a respective fastener therethrough wherein said respective fastener is adapted to connect said end cap retention member to the elongated crossarm member.

12. The connector assembly of claim 8, wherein the annular wall of the end cap retention member defines at least three apertures, wherein each aperture is adapted to receive a respective fastener therethrough wherein said respective fastener is adapted to connect said end cap retention member to the elongated crossarm member.

13. The connector assembly of claim 8, said horn cap further comprising a plurality of teeth adopted to engage a portion of the crossarm of the utility pole when attached thereon.

14. The connector assembly of claim 8, said horn cap having a flanged bottom portion defining a first plurality of apertures, said horn base having a flanged top portion defining a second plurality of apertures, wherein said first plurality of apertures aligns with said second plurality of apertures when the horn cap is connected to said horn base.

15. The connector assembly of claim 8, wherein the opposing concave portions of said horn cap and said horn base each further define at least one inner annular groove adapted to receive and enclose a head of a fastener when said opposing concave portions surround and engage the end cap retention member.

16. The connector assembly of claim 8, the end cap retention member further comprising a planar wall disposed at the first end portion and positioned transverse to the longitudinal axis.

17. The connector assembly of claim 8, wherein the horn cap, horn base, and end cap retention member are constructed of aluminum.

18. A hanger saddle assembly for an electrical utility temporary crossarm for quick connection to a crossarm of a utility pole, comprising:
a stirrup member having a pair of downwardly extending legs; each of the pair of downwardly extending legs having a respective bottom end portion which defines at least one aperture adapted to receive an elongated fastener therethrough;
a first clamp member having a concave region to accommodate a first portion of the electrical utility temporary crossarm, the first clamp member having a first angled region having a first lateral edge extending from an upper end of said concave region, the first clamp member having an upper end defining a first aperture adapted to receive the elongated fastener therethrough;
a second clamp member having a concave region to accommodate a second portion of the electrical utility temporary crossarm, the second clamp member having a second angled region having a second lateral edge extending from an upper end of said concave region, the second clamp member having an upper end defining a second aperture adapted to receive the elongated fastener therethrough;
a hinge that rotatably attaches the first clamp member and the second clamp member about a hinge axis.

19. The hanger saddle assembly of claim 18, each downwardly extending leg having a respective bottom end portion further defining at least a second aperture adapted to receive an elongated fastener therethrough, said second aperture adapted for adjusting a height of the temporary crossarm relative to the crossarm of the utility pole when said hanger saddle assembly is mounted on said crossarm of the utility pole.

20. The hanger saddle assembly of claim 18, further comprising an elongated fastener extending through the at least one aperture of each downwardly extending leg and extending through the first aperture of the first clamp member and through the second aperture of the second clamp member, said elongated fastener adapted to secure the bottom end portion of each downwardly extending leg to the first clamp member and to the second clamp member while clamping the first clamp member and the second clamp member around the first portion and the second portion of the temporary crossarm.

21. The hanger saddle assembly of claim 18, wherein the stirrup member is characterized as U-shaped.

22. The hanger saddle assembly of claim 18, wherein the stirrup member is characterized as C-shaped.
